(19) United States
(12) Patent Application Publication
(10) Pub. No.: US 2001/0052274 A1
(43) Pub. Date: Dec. 20, 2001

(54) Locking device and guide member for a movable jaw of an adjustable wrench

(76) Inventor: Mei-Jung Wang, Taichung (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 09/883,812

(22) Filed: Jun. 18, 2001

Related U.S. Application Data
(63) Continuation-in-part of application No. 09/595,232, filed on Jun. 16, 2000.

(51) Int. Cl. B25B 13/16

(52) U.S. Cl. 81/157

(57) ABSTRACT

An adjustable wrench includes a handle and a head extended from the handle. The head includes a fixed jaw, a movable jaw, and an adjusting screw. The movable jaw is rectilinearly movable relative to the fixed jaw upon rotation of the adjusting screw. A locking device is provided for locking the adjusting screw in place to thereby preventing rotation of the adjusting screw. A guide member is provided for guiding rectilinear movement of the movable jaw to thereby assure rectilinear movement of the movable jaw.

### CROSS REFERENCE TO RELATED APPLICATION

This is a continuation-in-part application of U.S. patent application Ser. No. 09/595,232 filed on Jun. 16, 2000, which is now abandoned.

### BACKGROUND OF THE INVENTION

1. Field of the Invention

The present invention relates to a locking device for retaining a movable jaw of an adjustable wrench after a fastener has been held between the movable jaw and a fixed jaw of the adjustable wrench. The present invention also relates to a guide member for assuring rectilinear movement of the movable jaw.

2. Description of the Related Art

FIG. 7 of the drawings illustrates a conventional adjustable wrench. It is well known to use an adjustable wrench for holding and driving fasteners (e.g., nuts, bolts, etc.) of various sizes. After the fastener has been securely clamped between the movable jaw 1 and the fixed jaw 3 by means of rotating an adjusting screw 2 of the adjustable wrench, the adjusting screw 2 is rotated in a reverse direction to form a gap between the jaws and the fastener for allowing easy disengagement of the jaws from the fastener and reengagement of the jaws with the fastener. The disengagement/reengagement of the jaws from/with the fastener are repeated until the fastener is tightened or loosened. If the gap is too small, the disengagement/reengagement is very difficult, yet the corner areas of a hexagonal outer periphery of the fastener will be damaged if the gap is too large. In addition, the adjusting screw tends to be rotated inadvertently during operation of the adjustable wrench such that the gap becomes larger, which results in damage to the corner areas of the fastener. The adjustable wrench is thus known as “nut killer”. Further, the upper and lower side walls 4 (only one of them is shown) of the head of the adjustable wrench are apt to damaged or deformed, as some users use the adjustable wrench as a hammer. As a result, when a fastener is held between the movable jaw 1 and the fixed jaw, the movable jaw 1 moves not only along a direction parallel to a longitudinal direction of the adjusting screw but also in a direction transverse to the longitudinal direction and thus causes damage to the corner areas of the fastener.

U.S. Pat. No. 5,301,576 to Nye issued on Apr. 12, 1994 discloses a locking and clamping adjustable wrench, yet the drawback of transverse movement of the movable jaws still exists. In addition, the adjusting screw cannot be locked in place after a fastener is clamped between the fixed jaw and the movable jaw. U.S. Pat. No. 4,967,625 to Kolari et al. discloses an adjustable jaw socket to solve this problem, yet it can only be used in socket type adjustable wrench. The adjusting screw of this adjustable wrench cannot be locked in place either after a fastener is clamped between the fixed jaw and the movable jaw.

### SUMMARY OF THE INVENTION

It is an object of the present invention to provide a locking device for retaining a movable jaw of an adjustable wrench after a fastener has been held between the movable jaw and a fixed jaw of the adjustable wrench.

It is another object of the present invention to provide a guide member for assuring rectilinear movement of the movable jaw of an adjustable wrench.

In accordance with a first aspect of the invention, an adjustable wrench comprises:

a handle;

a head extended from the handle, the head including a fixed jaw, a movable jaw, and an adjusting screw having a longitudinal hole, the movable jaw being rectilinearly movable relative to the fixed jaw upon rotation of the adjusting screw; and

means for locking the adjusting screw in place after a fastener is clamped between the fixed jaw and the movable jaw;

the movable jaw including a rack portion for engaging with the adjusting screw, the head including a track groove along which the rack portion of the movable jaw is moved;

the head including a compartment that is defined by two mutually facing walls and that is communicated with the track groove, the adjusting screw being freely rotatably received in the compartment, one of the walls including a blind hole, the other wall including a screw hole, the locking means including a locking rod that extends through the blind hole, the longitudinal hole of the adjusting screw, and the screw hole, the locking rod including an enlarged threaded portion that engages with the screw hole and that is located outside the adjusting screw, the locking rod being rotatable to a position such that the enlarged threaded portion of the locking rod abuts against the adjusting screw and thus prevents rotation of the adjusting screw.

In accordance with a second aspect of the invention, an adjustable wrench comprises:

a handle;

a head extended from the handle, the head including a fixed jaw, a movable jaw, and an adjusting screw, the movable jaw being rectilinearly movable relative to the fixed jaw upon rotation of the adjusting screw, the movable jaw including a rack portion for engaging with the adjusting screw, the head including a track groove along which the rack portion of the movable jaw is moved, the head including an end opposite to the fixed jaw, the end of the head including two mutually facing upper and lower side walls, the upper side wall including a first hole, the lower side wall including a second hole that is aligned with the first hole, the movable jaw further including a groove; and

a guide member extending through the first hole, the groove of the movable jaw, and the second hole;

wherein when the adjusting screw is turned, the movable jaw moves rectilinearly along a direction parallel to a longitudinal direction of the adjusting screw under guidance by the guide member, thereby preventing transverse movement of the movable jaw in a direction transverse to the longitudinal direction of the adjusting screw.

In accordance with a third aspect of the invention, an adjustable wrench comprises:

a handle;

a head extended from the handle, the head including a fixed jaw, a movable jaw, and an adjusting screw, the movable jaw being rectilinearly movable relative to the fixed jaw upon rotation of the adjusting screw;

means for locking the adjusting screw in place after a fastener is clamped between the fixed jaw and the movable jaw; and

means for guiding rectilinear movement of the movable jaw along a direction parallel to a longitudinal direction of the adjusting screw and preventing transverse movement of the movable jaw in a direction transverse to the longitudinal direction of the adjusting screw.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a head portion of an adjustable wrench in accordance with the present invention.

FIG. 2 is an exploded perspective view of the head portion of the adjustable wrench in accordance with the present invention.

FIG. 3 is a top view of the head portion of the adjustable wrench in accordance with the present invention,.

FIG. 4 is a top view similar to FIG. 3, illustrating operation of the adjustable wrench.

FIG. 5 is a top view similar to FIG. 4, wherein a locking device of the adjustable wrench is in a locking position for preventing displacement of an adjusting screw.

FIG. 6 is an exploded perspective view of a modified embodiment of the head portion of the adjustable wrench in accordance with the present invention.

FIG. 7 is a top view of a conventional adjustable wrench.

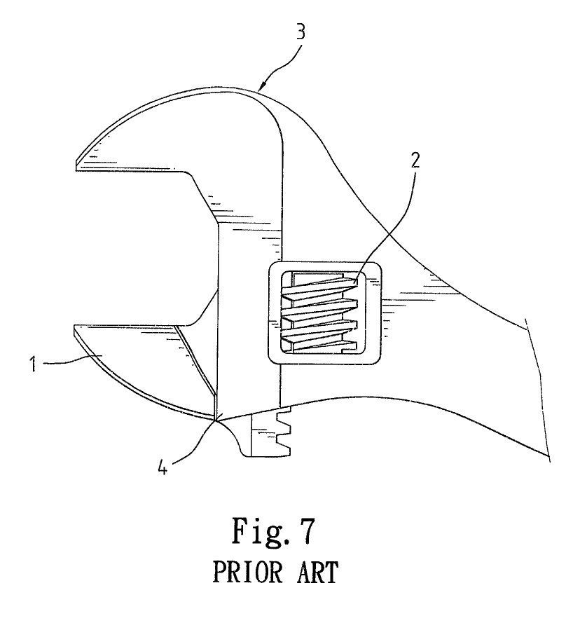

### DETAILED DESCRIPTION OF THE PREFERRED EMBODIMENT

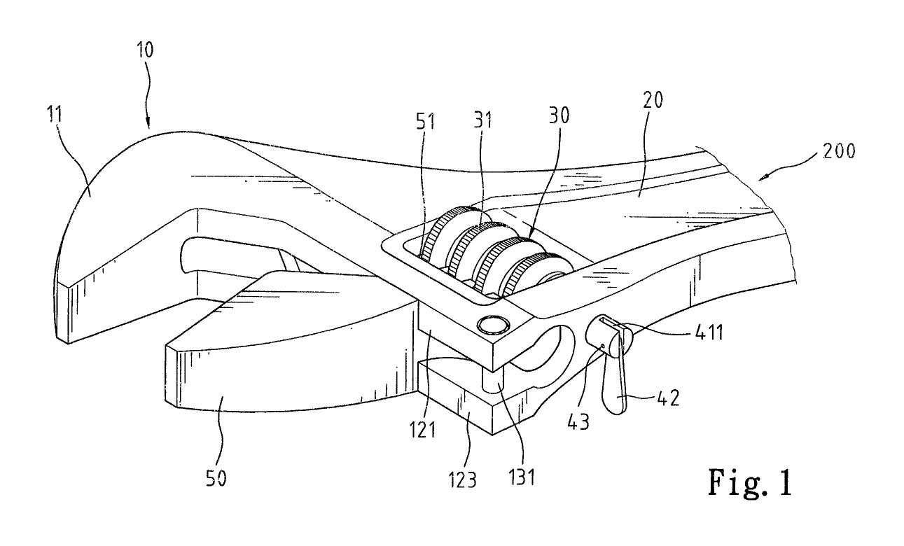

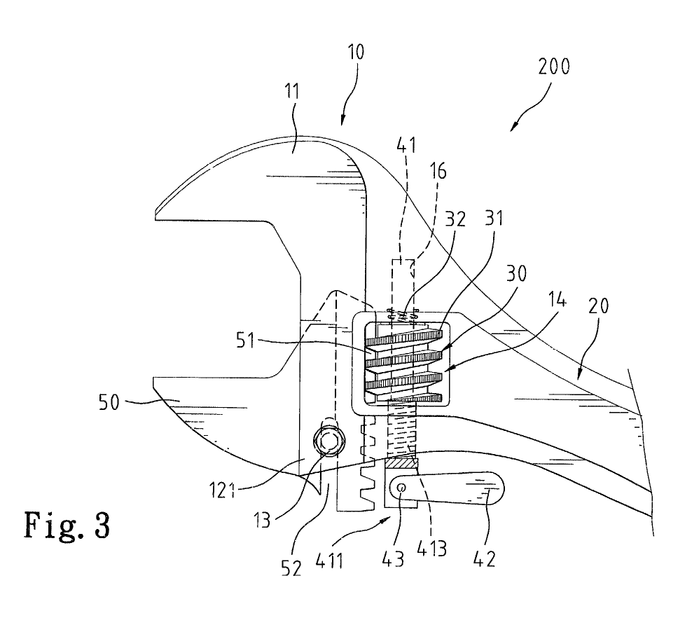

Referring to FIGS. 1 through 6 and initially to FIGS. 1 through 3, an adjustable wrench 200 in accordance with the present invention generally includes a handle 20 and a head 10 extended from the handle 20. The head 10 includes a fixed jaw 11 formed on a side thereof and a movable jaw 50. The other side of the head 10 includes a track groove 12 defined therein along which a rack portion 51 of the movable jaw is moved. The other side of the head 10 includes two mutually facing upper and lower side walls 121 and 123, the upper side wall 121 having a hole 122 and the lower side wall 123 having a screw hole 124 aligned with the hole 122. A guide member 13 (in the form of a bolt) is extended through the hole 122 and the screw hole 124. As illustrated in FIG. 3, the bolt 13 is received in a groove 52 in the movable jaw 50 to guide rectilinear movement of the movable jaw 50 relative to the fixed jaw 11, thereby assuring rectilinear movement of the movable jaw 11 along a direction parallel to a longitudinal direction of the adjusting screw 30 and preventing transverse movement of the movable jaw 50 in a direction transverse to the longitudinal direction of the adjusting screw 30. The diameter of the bolt 131 is the same as or slightly smaller than a width of the groove 52. In conventional designs, the movable jaw 11 tends to move in a transverse direction when it is moved away from the fixed jaw 11 by a larger distance, yet this drawback is mitigated by the 12 provision of the guide member (i.e., the bolt) 13. The bolt 13 also provides improved structural strength for the head 10 of the adjustable wrench 200.

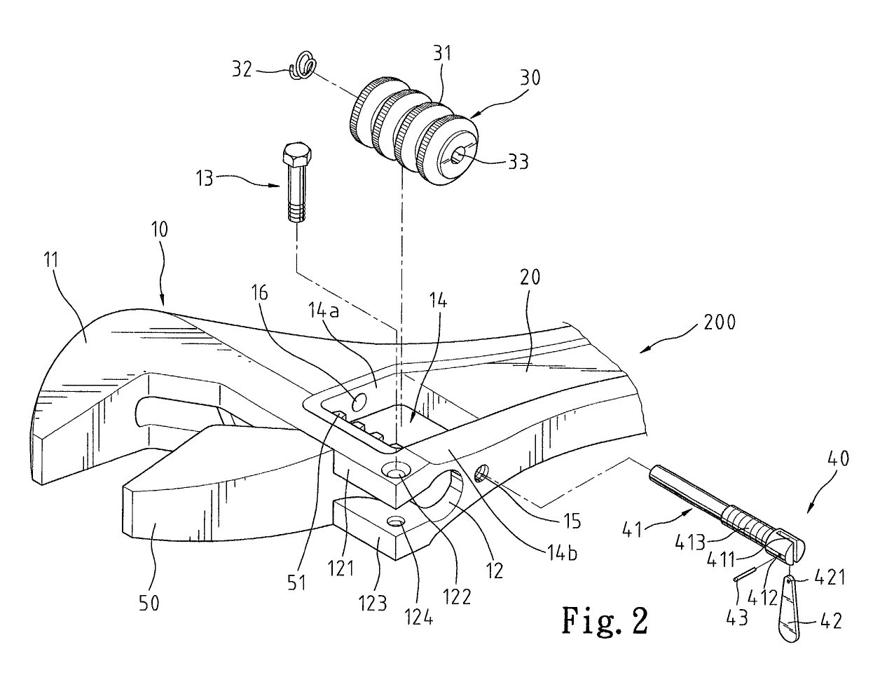

The head 10 of the adjustable wrench 200 further includes an opening or compartment 14 for rotatably receiving an adjusting screw 30 that meshes with the rack portion 51 of the movable jaw 50. A blind hole 16 is defined in a wall 14a that defines a portion of the compartment 14, and a screw hole 15 is defined in another wall 14b that defines another portion of the compartment 14 and that faces the wall 14a, best shown in FIG. 2.

A locking device 40 is provided to retain the adjusting screw 30 in place after the movable jaw 50 has been moved to a position for tightening/loosening operation of a fastener. As illustrated in FIG. 2, the locking device 40 includes a locking rod 41 and a turn-piece 42. The locking rod 41 has an enlarged threaded portion 413 and a slit 411 defined in an end thereof. A pin 43 is extended through a transverse through-hole 412 in the end of the locking rod 41 and a hole 421 in an end of the turn-piece 42 that is received in the slit 411 of the locking rod 41. The locking rod 41 is extended through the screw hole 15, a longitudinal hole 33 of the adjusting screw 30, and the blind hole 16. An elastic member 32 is mounted around the locking rod 41 and attached between the wall 14a and an end of the adjusting screw 30 for biasing the adjusting screw 30 toward the other wall 14b. The adjusting screw 30 may rotate freely in the compartment 14 for moving the movable jaw 50 away from or toward the fixed jaw 11. The adjusting screw 30 has a helical anti-slip surface 31 to avoid slip during manual rotation.

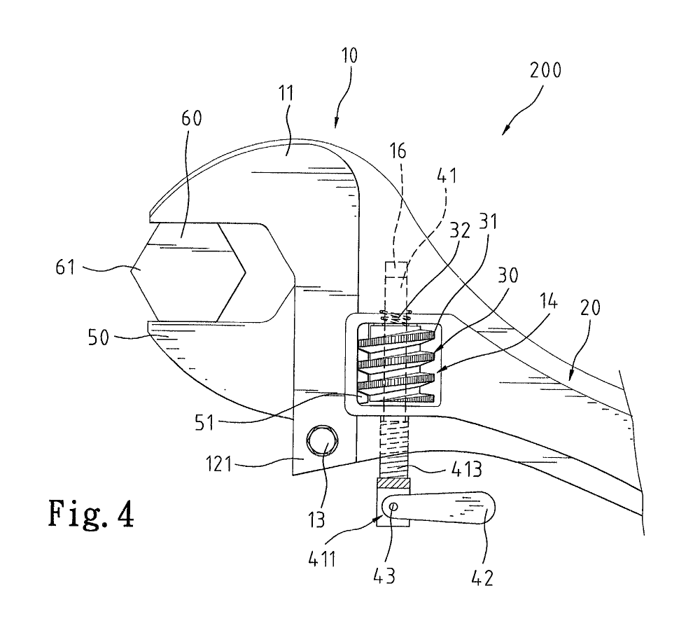

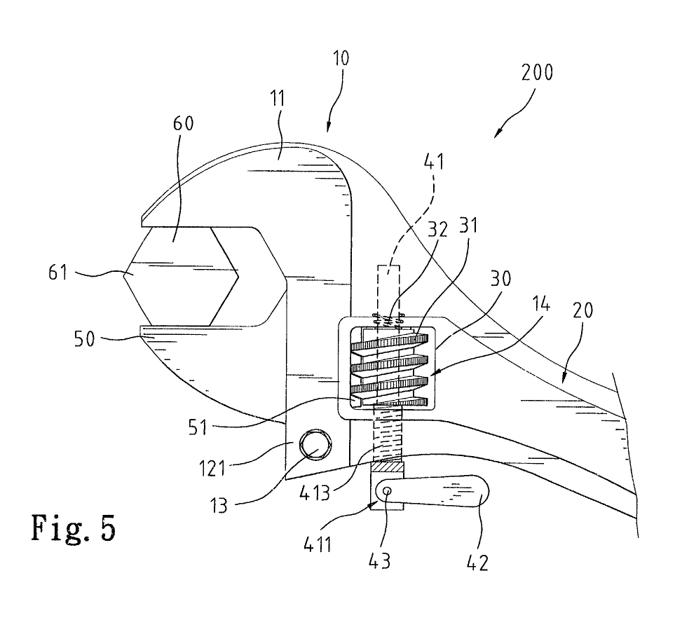

Referring to FIG. 4, when in use, the movable jaw 50 is moved toward the fixed jaw 60 upon manual rotation of the adjusting screw 30 to securely clamp a fastener (e.g., a nut 60). Next, the adjusting screw 30 is rotated in a reverse rotation to obtain required gap between the jaws 11 and 50 and the nut 60 for operation. Then, the turn-piece 42 is turned until the enlarged threaded portion 413 abuts against the adjusting screw 30 (see FIG. 5) and thus prevents rotation of the adjusting screw 30. Thus, potential damage to the corner areas 61 of the nut 60 is prevented.

Of course, the adjustable wrench 200 may be retained in this status such that it can remain on the nut 60 even if the user's hand lets go. Thus, the user may leave the working site for other priority matters, and the adjustable wrench will be still there when he/she returns.

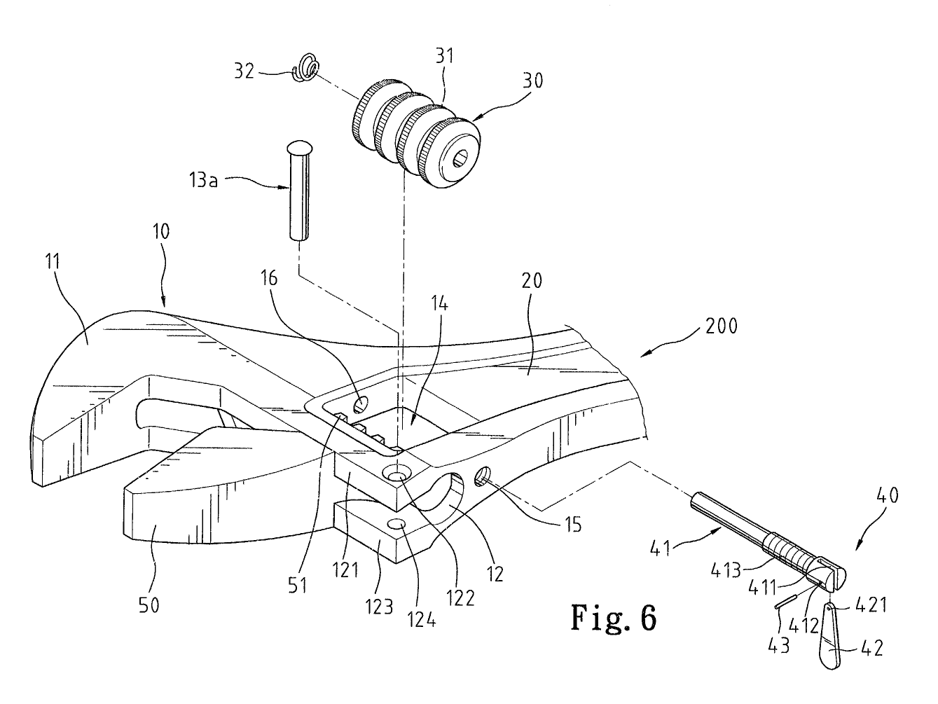

FIG. 6 illustrates a modified embodiment of the adjustable wrench, wherein the guide member is in the form of a pin 13a, and the hole 124 in the lower side wall 123 is not a screw hole.guide member 13 (in the form of a bolt) is extended through the hole 122 and the screw hole 124.

According to the above description, it is appreciated that the guide member 13 is received in the groove 52 in the movable jaw 50 to guide rectilinear movement of the movable jaw 50 relative to the fixed jaw 11, thereby assuring rectilinear movement of the movable jaw 11 along a direction parallel to a longitudinal direction of the adjusting screw 30 and preventing transverse movement of the movable jaw 50 in a direction transverse to the longitudinal direction of the adjusting screw 30. This eliminates the drawback of transverse movement of the movable jaw in conventional designs. The guide member 13 also provides improved structural strength for the head 10 of the adjustable wrench 200. In addition, the adjusting screw can be reliably retained in place by the enlarged threaded portion 413 of the locking rod 41. Thus, the adjustable wrench can remain on the nut 60 even if the user's hand lets go. Thus, the user may leave the working site for other priority matters, and the adjustable wrench will be still there when he/she returns.

Although the invention has been explained in relation to its preferred embodiment, it is to be understood that many other possible modifications and variations can be made without departing from the spirit and scope of the invention as hereinafter claimed.

What is claimed is:

1. An adjustable wrench comprising:
a handle;
a head extended from the handle, the head including a fixed jaw, a movable jaw, and
an adjusting screw having a longitudinal hole, the movable jaw being rectilinearly movable relative to the fixed jaw upon rotation of the adjusting screw; and
means for locking the adjusting screw in place after a fastener is clamped between the fixed jaw and the movable jaw;
the movable jaw including a rack portion for engaging with the adjusting screw, the head including a track groove along which the rack portion of the movable jaw is moved;
the head including a compartment that is defined by two mutually facing walls and that is communicated with the track groove, the adjusting screw being freely rotatably received in the compartment, one of the walls including a blind hole, the other wall including a screw hole, the locking means including a locking rod that extends through the blind hole, the longitudinal hole of the adjusting screw, and the screw hole, the locking rod including an enlarged threaded portion that engages with the screw hole and that is located outside the adjusting screw, the locking rod being rotatable to a position such that the enlarged threaded portion of the locking rod abuts against the adjusting screw and thus prevents rotation of the adjusting screw.

2. The adjustable wrench as claimed in claim 1, wherein the locking rod includes an end, further comprising a turn-piece mounted to the end of the locking rod for manually turning the locking rod by the turn-piece.

3. The adjustable wrench as claimed in claim 2, wherein the end of the locking rod includes a slit and a transverse through-hole, and wherein the turn-piece includes an end received in the slit of the locking rod, the end of the turn-piece including a hole, further comprising a pin extended through the transverse through-hole of the end of the locking rod and the hole of the end of the turn-piece.

4. The adjustable wrench as claimed in claim 1, wherein the head includes an end opposite to the fixed jaw, the end of the head including two mutually facing upper and lower side walls, the upper side wall including a first hole, the lower side wall including a second hole that is aligned with the first hole, further comprising a guide member extended through the first hole and the second hole, the movable jaw comprising a groove through which the guide member extends;
when the adjusting screw is turned, the movable jaw moves rectilinearly along a direction parallel to a longitudinal direction of the adjusting screw under guidance by the guide member, thereby preventing transverse movement of the movable jaw in a direction transverse to the longitudinal direction of the adjusting screw.

5. The adjustable wrench as claimed in claim 4, wherein the guide member is a bolt.

6. The adjustable wrench as claimed in claim 4, wherein the guide member is a pin.

7. An adjustable wrench comprising:
a handle;
a head extended from the handle, the head including a fixed jaw, a movable jaw, and an adjusting screw, the movable jaw being rectilinearly movable relative to the fixed jaw upon rotation of the adjusting screw, the movable jaw including a rack portion for engaging with the adjusting screw, the head including a track groove along which the rack portion of the movable jaw is moved, the head including an end opposite to the fixed jaw, the end of the head including two mutually facing upper and lower side walls, the upper side wall including a first hole, the lower side wall including a second hole that is aligned with the first hole, the movable jaw further including a groove; and
a guide member extending through the first hole, the groove of the movable jaw, and the second hole;
wherein when the adjusting screw is turned, the movable jaw moves rectilinearly along a direction parallel to a longitudinal direction of the adjusting screw under guidance by the guide member, thereby preventing transverse movement of the movable jaw in a direction transverse to the longitudinal direction of the adjusting screw.

8. The adjustable wrench as claimed in claim 7, wherein the guide member is a bolt.

9. The adjustable wrench as claimed in claim 7, wherein the guide member is a pin.

10. The adjustable wrench as claimed in claim 7, wherein the head includes a compartment that is defined by two mutually facing walls and that is communicated with the track groove, the adjusting screw being freely rotatably received in the compartment.

11. The adjustable wrench as claimed in claim 10, wherein one of the walls includes a blind hole and the other wall includes a screw hole, the adjusting screw including a longitudinal hole, further comprising a locking rod that extends through the blind hole, the longitudinal hole of the adjusting screw, and the screw hole, the locking rod locking the movable jaw in place after a fastener is clamped between the fixed jaw and the movable jaw.

12. The adjustable wrench as claimed in claim 11, wherein the locking rod includes an enlarged threaded portion that engages with the screw hole and that is located outside the adjusting screw, and wherein the locking rod is rotatable to a position such that the enlarged threaded portion of the locking rod abuts against the adjusting screw and thus prevents rotation of the adjusting screw.

13. The adjustable wrench as claimed in claim 12, wherein the locking rod includes an end, further comprising a turn-piece mounted to the end of the locking rod for manually turning the locking rod by the turn-piece.

14. An adjustable wrench comprising:
a handle;
a head extended from the handle, the head including a fixed jaw, a movable jaw, and an adjusting screw, the movable jaw being rectilinearly movable relative to the fixed jaw upon rotation of the adjusting screw;
means for locking the adjusting screw in place after a fastener is clamped between the fixed jaw and the movable jaw; and
means for guiding rectilinear movement of the movable jaw along a direction parallel to a longitudinal direction of the adjusting screw and preventing transverse movement of the movable jaw in a direction transverse to the longitudinal direction of the adjusting screw.

15. The adjustable wrench as claimed in claim 14, wherein the head includes a compartment that is defined by two mutually facing walls and that is communicated with the track groove, the adjusting screw being freely rotatably received in the compartment.

16. The adjustable wrench as claimed in claim 15, wherein one of the walls includes a blind hole and the other wall includes a screw hole, the adjusting screw including a longitudinal hole, the locking means comprising a locking rod that extends through the blind hole, the adjusting screw, and the screw hole, the locking rod locking the movable jaw in place after a fastener is clamped between the fixed jaw and the movable jaw.

17. The adjustable wrench as claimed in claim 16, wherein the locking rod includes an enlarged threaded portion that engages with the screw hole and that is located outside the adjusting screw, and wherein the locking rod is rotatable to a position such that the enlarged threaded portion of the locking rod abuts against the adjusting screw and thus prevents rotation of the adjusting screw.

18. The adjustable wrench as claimed in claim 17, wherein the locking rod includes an end, further comprising a turn-piece mounted to the end of the locking rod for manually turning the locking rod by the turn-piece.

19. The adjustable wrench as claimed in claim 14, wherein the head includes an end opposite to the fixed jaw, the end of the head including two mutually facing upper and lower side walls, the upper side wall including a first hole, the lower side wall including a second hole that is aligned with the first hole, the guiding means including a bolt extended through the first hole and the second hole, the movable jaw comprising a groove through which the bolt extends, whereby rectilinear movement of the movable jaw is guided by the bolt.

20. The adjustable wrench as claimed in claim 14, wherein the head includes an end opposite to the fixed jaw, the end of the head including two mutually facing upper and lower side walls, the upper side wall including a first hole, the lower side wall including a second hole that is aligned with the first hole, the guiding means including a pin extended through the first hole and the second hole, the movable jaw comprising a groove through which the pin extends, whereby rectilinear movement of the movable jaw is guided by the pin.
